(19) United States
(12) Patent Application Publication
(10) Pub. No.: US 2011/0262782 A1
(43) Pub. Date: Oct. 27, 2011

(54) BATTERY EXPLOSION-PROOF STRUCTURE AND POWER BATTERY HAVING THE SAME

(76) Inventors: Jianhua Zhu, Shenzhen (CN); Qing Lai, Shenzhen (CN); Zhiliang Zeng, Shenzhen (CN)

(21) Appl. No.: 13/092,987

(22) Filed: Apr. 25, 2011

(30) Foreign Application Priority Data
Apr. 23, 2010 (CN) 201020175351.3

(51) Int. Cl. H01M 2/12

(52) U.S. Cl. 429/54

(57) ABSTRACT

An explosion-proof device for a battery comprises: a vent formed in a battery shell of the battery; a valve core movably disposed in the vent to seal and open the vent; a support mounted on an outer wall of the battery shell; and an elastic element. One end of the elastic element is connected to the support and another end of the elastic element is connected to the valve core so as to normally push the valve core to seal the vent. Each of a power battery and a power battery module includes the explosion-proof device.

### CROSS-REFERENCE TO RELATED APPLICATIONS

This application claims the benefits of and priority to Chinese Application No. 201020175351.3, filed on Apr. 23, 2010, the content of which is incorporated by reference herein in its entirety.

### FIELD

The present disclosure relates to the field of secondary battery, more particularly to an explosion-proof device, a power battery and a power battery module comprising the same.

### BACKGROUND

For a secondary battery such as a Li-ion battery, gas may be produced inside the battery when some abnormal conditions such as short circuit and over-high operating temperature occur, and thus the internal pressure of the battery may increase rapidly. If the gas cannot be discharged timely, the battery may be exploded. Therefore, an explosion-proof device is generally mounted onto the battery shell.

A safety valve may be a conventional explosion-proof device. When the internal pressure of the battery reaches a critical value, the valve is opened under the gas pressure to discharge the gas; and when the internal pressure of the battery is lower than the critical value, the valve is closed. The safety requirements for a power battery are high because a power battery is large; has a high capacity, high voltage and large current; and operates in a severe environment.

Chinese patent application No. CN200820169978 discloses a battery safety valve having a connecting structure between a valve body and a valve cap, but the connecting structure is not reliable and can be easily damaged. In addition, the contact area between the valve core and a vent formed in the battery shell is small, and consequently the air-tightness inside the battery is decreased. Furthermore, the safety valve has a complicated structure, high cost, and short service life; and is difficult to manufacture, assemble and disassemble.

### SUMMARY

An object of the present disclosure is to provide an explosion-proof device which is simple in structure, low in cost, long in service life, high in reliability and easy to manufacture, assemble and disassemble.

Another object of the present disclosure is to provide a power battery comprising the explosion-proof device.

Still another object of the present disclosure is to provide a power battery module comprising the explosion-proof device.

An embodiment according to an aspect of the present disclosure provides an explosion-proof device for a battery. The device comprises a vent formed in a shell of the battery; a valve core movably disposed in the vent to seal and open the vent; a support mounted on an outer wall of the battery shell; and an elastic element connected to the support and the valve core at two ends of the elastic element respectively so as to normally push the valve core to seal the vent.

According to another aspect of the present disclosure, a power battery comprises a battery shell; an electrolyte sealed in the battery shell; an electrode assembly disposed in the battery shell; and an explosion-proof device mounted on an outer wall of the battery shell. The explosion-proof device comprises: a vent formed in the shell of the battery; a valve core movably disposed in the vent to seal and open the vent; a support mounted on the outer wall of the battery shell; and an elastic element connected to the support and the valve core at two ends of the elastic element respectively so as to normally push the valve core to seal the vent.

According to yet another aspect of the present disclosure, a power battery module comprises a plurality of power batteries. Each power battery comprises: a battery shell; an electrolyte sealed in the battery shell; an electrode assembly disposed in the battery shell; and an explosion-proof device mounted on an outer wall of the battery shell. The explosion-proof device comprises: a vent formed in the shell of the battery; a valve core movably disposed in the vent to seal and open the vent; a support mounted on the outer wall of the battery shell; and an elastic element connected to the support and the valve core at two ends of the elastic element respectively so as to normally push the valve core to seal the vent.

An explosion-proof device according to embodiments of the present disclosure is reliable to ensure the safety of the battery, and is simple in structure, low in cost, long in service life, high in reliability and easy to manufacture, assemble and disassemble.

Additional aspects and advantages of the embodiments of the present disclosure will be given in part in the following descriptions, become apparent in part from the following descriptions, or be learned from the practice of the embodiments of the present disclosure.

### DESCRIPTION OF THE DRAWINGS

These and other aspects and advantages of the disclosure will become apparent and more readily appreciated from the following descriptions taken in conjunction with the drawings in which:

FIG. 1 is a sectional view of an explosion-proof device according to an embodiment of the present disclosure;

FIG. 2 is a sectional view of an explosion-proof device according to another embodiment of the present disclosure;

FIG. 3 is a sectional view of an explosion-proof device according to yet another embodiment of the present disclosure;

FIG. 4 is a partial perspective view of an explosion-proof device according to still another embodiment of the present disclosure;

FIG. 5 is a sectional view of the explosion-proof device shown in FIG. 4, in which the valve core closes and seals the vent;

FIG. 6 is a sectional view of the explosion-proof device shown in FIG. 4, in which the valve core opens the vent;

FIG. 7 is a perspective schematic view of a power battery comprising the explosion-proof device according to an embodiment of the present disclosure; and

FIG. 8 is a perspective schematic view of a power battery module comprising the explosion-proof device according to an embodiment of the present disclosure.

### DETAILED DESCRIPTION OF THE EMBODIMENT

Reference will be made in detail to embodiments of the present disclosure. The embodiments described herein with reference to the accompanying drawings are explanatory and illustrative, which are used to generally understand the present disclosure. The embodiments shall not be construed to limit the present disclosure. The same or similar elements and the elements having same or similar functions are denoted by like reference numerals throughout the descriptions.

In the description, relative terms such as “lower”, “upper”, “up” as well as derivative thereof (e.g., “upwardly”, etc.) should be construed to refer to the orientation as then described or as shown in the drawings under discussion. These relative terms are for convenience of description and do not require that the present disclosure be constructed or operated in a particular orientation.

Unless specified or limited otherwise, the terms “mounted,” and “connected” and variations thereof are used broadly and encompass both direct and indirect mountings, connections, supports, and couplings.

The explosion-proof device according to embodiments of the present disclosure may be described below with reference to the drawings.

According to an embodiment of the present disclosure, the explosion-proof device 100 for a battery may comprise a vent 51, a valve core 1, a support and an elastic element 2.

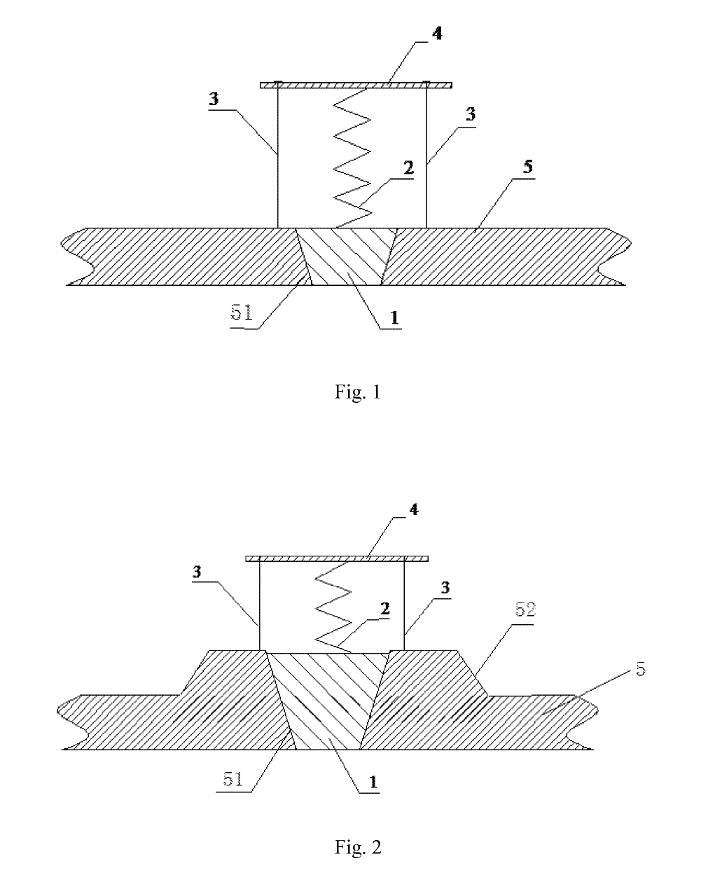

Particularly, the vent 51 is formed in a battery shell 5 of the battery to provide communications between the interior of the battery and the exterior of the battery (i.e., the ambient environment). The valve core 1 is movably disposed in the vent 51 so as to close (seal) and open the vent 51. The support is mounted on the outside (i.e., the upper surface in FIG. 1) of the battery shell 5. One end of the elastic element 2 is connected to the support and the other end of the elastic element 2 is connected to the valve core 1 so as to normally push the valve core 1 to seal the vent 51.

When the battery operates normally, that is, the internal pressure of the battery is less than a safety value, the inward pushing force applied to the valve core 1 by the elastic element 2 is greater than the force applied to the valve core 1 by the gas inside the battery, so that the valve core 1 seals the vent 51.

When the battery is subject to heat or a short circuit, the internal pressure of the battery may increase and reach or exceed the critical safety value, that is, the outward pushing force applied by the gas is increased. When the outward pushing force applied to the valve core 1 by the gas inside the battery is greater than the inward pushing force applied to the valve core 1 by the elastic element 2, the valve core 1 is pushed to move outwards (i.e. upwards in FIG. 1) by the gas inside the battery against the inward pushing force of the elastic element 2, so that the vent 51 is opened and the gas is discharged via a gap between the valve core 1 and the vent 51 so as to release the internal pressure.

With the discharging of the gas, the internal pressure is reduced. When the internal pressure is lower than the critical safe value, that is, the outward pushing force applied to the valve core 1 by the gas inside the battery is smaller than the inward pushing force applied to the valve core 1 by the elastic element 2, the valve core 1 is pushed by the elastic element 2 against the inward pushing force of the gas inside the battery to move inwards so as to seal the vent 51 again.

According to the embodiment of the present disclosure, by forming the vent 51 in the battery shell 5, movably disposing the valve core 1 within the vent 51, and connecting one end of the elastic element 2 to the support mounted on the battery shell 5 and another end of the elastic element 2 to the valve core 1, the battery is prevented from exploding. Therefore, the explosion-proof device 100 is simple in structure, low in cost, long in service life, high in reliability, and easy to manufacture, assemble and disassemble.

It should be noted that, in the description of the embodiments of the present disclosure, a direction towards the interior of the battery is referred to as the inward direction (i.e., the downward direction in FIG. 1), and a direction towards the exterior of the battery is referred to as the outward direction (i.e., the upward direction in FIG. 1).

As shown in FIG. 1, in some embodiments of the present disclosure, the support may comprise a plurality of support bars 3 and a plate 4. The plurality of support bars 3 may be disposed around the vent 51, and one end of each support bar 3 is mounted onto the outer wall of the battery shell 5. The plate 4 is mounted onto the other ends of the support bars 3 so as to oppose the vent 51. The other end of the elastic element 2 may be fixed to the plate 4. According to the embodiment of the present disclosure, the support is simple in structure, low in cost, high in reliability, and easy to manufacture and assemble.

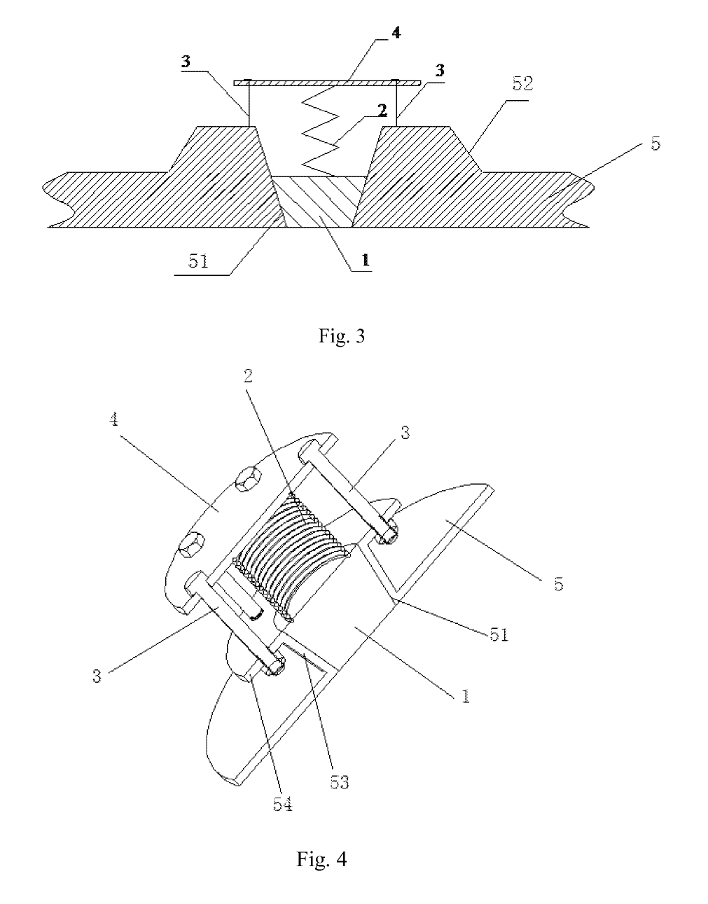

As shown in FIG. 1, each support bar 3 may be a bolt. Accordingly, the plate 4 is formed with a plurality of first holes and the battery shell 5 is formed with a plurality of second threaded holes. The one end of the support bar 3 is connected to the outer wall of the battery shell 5 by passing through a first hole in the plate 4 and being screwed in a corresponding second threaded hole in the battery shell 5. The first holes may be threaded holes or non-threaded holes. Alternatively, as shown in FIG. 2, the plate has a plurality of first threaded holes and the battery shell has a plurality of second threaded holes, and the one end of each support bar is screwed into one of the first threaded holes in the plate and the second end of each support bar is screwed in the corresponding one of the second threaded holes in the battery shell.

The amount of elastic deformation of the elastic element 2 may be adjusted by adjusting the length of the support bars 3 screwed into the battery shell 5, thus adjusting the pressure, i.e., the critical safety value of the gas pressure inside the battery, under which the valve core 1 opens the vent 51. In addition, the bolt is easy to manufacture, assemble and disassemble, so that the elastic element 2 and valve core 1 may be easy to replace.

According to an embodiment of the present disclosure, as shown in FIG. 1, the elastic element 2 may be a spring such as a compressed spring. A lower end of the spring may be connected to a center of the outer end surface of the valve core 1, so that the force applied by the spring may be distributed to the valve core 1 uniformly. Alternatively, the elastic element 2 may be a metal elastic sheet or an air bag.

In some embodiments of the present disclosure, a length-diameter ratio of the spring may be particularly about 2:1 to about 1:1. If the length-diameter ratio of the spring is too large, radial deformation (i.e., bending in the transversal direction of the spring) may occur in the spring when the valve core 1 moves outwards, and consequently the valve core 1 can not be opened smoothly and the discharging of the gas inside the battery may be affected. If the length-diameter ratio of the spring is too small, the outward displacement of the valve core 1 may be small (that is, the gap between the vent 51 and the valve core 1 is small), so that the gas may be discharged slowly.

As shown in FIG. 1, particularly, both the vent 51 and the valve core 1 have an inverted truncated cone shape, so that the valve core 1 and the inner surface of the vent 51 may contact with each other with high air tightness, and the vent 51 and the valve core 1 may be easier to machine and manufacture. However, the present disclosure is not limited to this configuration. For example, the valve core 1 may also have a pyramid shape, and the vent 51 may have a shape matching the valve core 1.

In some embodiments, considering the relationship between an area of a single coil of the spring and an area of an outer end surface (i.e., the upper end surface of the valve core 1 in FIG. 1) of the valve core 1, an outer radius of the spring may be not less than (⅔) ^{1/2} of a radius of the outer end surface of the valve core 1, but not greater than the radius of the outer end surface of the valve core 1. If the area of a single coil of the spring is too small with respect to the area of the outer end surface of the valve core 1, the valve core 1 may open the vent 51 even when the gas pressure inside the battery does not reach the critical safety value. In addition, the valve core 1 may overturn under the gas pressure, which is disadvantageous to the discharging of the gas. It is proved by experiments that the area of a single coil of the spring not less than ⅔ of the area of the outer end surface of the valve core 1 is preferable.

In some embodiments of the present disclosure, there are no limits on the materials of the valve core 1, for example, metal, plastic, rubber or other materials may be used. Preferably, the valve core 1 is made of plastics. The valve core 1 made of plastics may improve the sealing performance, may not be easy to creep, and may have good anti-aging property. In addition, when the valve core 1 made of plastics moves in the vent 51, only the valve core 1 is subject to abrasion, thus reducing the abrasion of the battery shell 5. Furthermore, the valve core 1 made of plastics may be low in cost and easy to replace.

According to embodiments of the present disclosure, the vent 51 is formed in the battery shell 5, and the valve core 1 is movably disposed in the vent 51, so that the vent 51 may be easy to form and low in cost.

The explosion-proof device 100 according to another embodiment of the present disclosure will be described below with reference to FIG. 2. As shown in FIG. 2, the outer wall of the battery shell 5 is formed with a boss 52 through which the vent 51 extends. A plurality of support bars 3 may be respectively mounted onto the boss 52. Alternatively, the support bars 3 may be mounted onto the battery shell 5 around the boss 52. Of course, compared with the support bar 3 directly mounted onto the boss 52, the support bar 3 mounted onto the battery shell 5 may be longer. The depth, i.e., the size in an inside and outside direction (i.e., the up and down direction in FIG. 2), of the vent 51 may be increased by forming the boss 52 on the outer wall of the battery shell 5, and thus the size of the valve core 1 may be increased accordingly. Therefore, the contact area between the valve core 1 and the vent 51 may be increased, thus enhancing the sealing performance. In some embodiments of the present disclosure, the boss 52 may be integral with the battery shell 5. The boss 52 may also be welded onto the battery shell 5 after being formed separately. The other structures of the explosion-proof device 100 shown in FIG. 2 may be the same as those of the explosion-proof device 100 shown in FIG. 1, so that a detailed description thereof will be omitted here.

FIG. 3 shows the explosion-proof device 100 according to yet another embodiment of the present disclosure. As shown in FIG. 3, the size of the valve core 1 in the inside and outside direction may be less than the depth of the vent 51, and an inner end surface of the valve core 1 may be aligned with an inner wall surface of the battery shell 5. As shown in FIG. 1 and FIG. 2, the size of the valve core 1 in the inside and outside direction may be substantially equal to the depth of the vent 51.

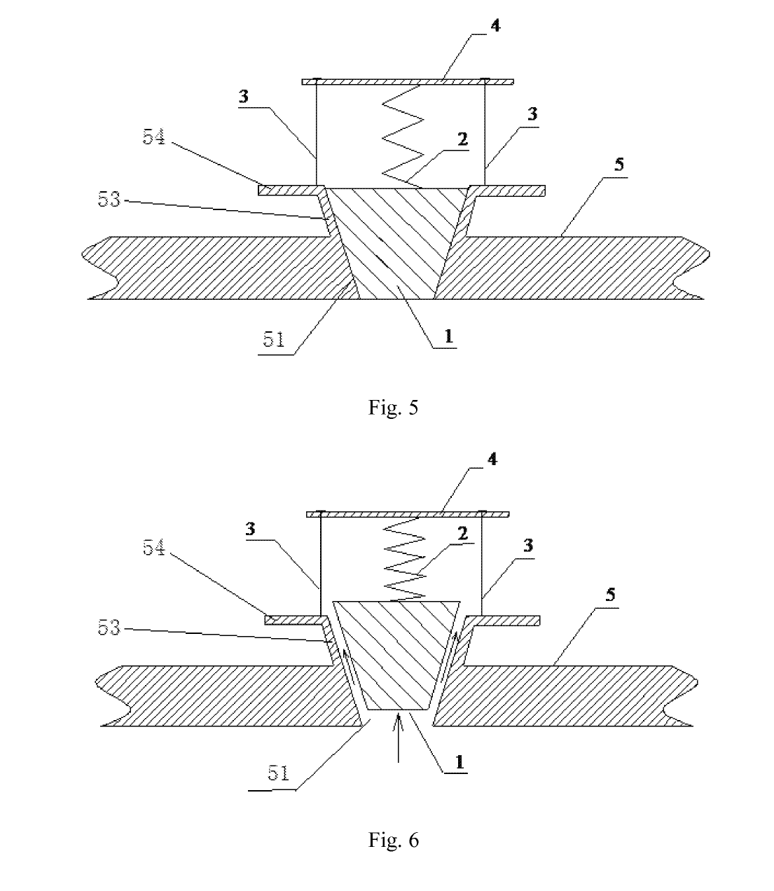

The explosion-proof device 100 according to still another embodiment of the present disclosure will be described below with reference to FIGS. 4-6.

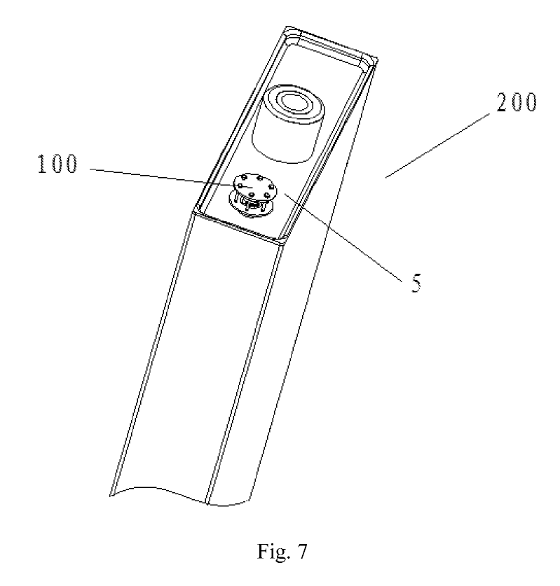

As shown in FIGS. 4-6, an extending portion 53 may be extended from the outer wall of the battery shell 5, a flange 54 may be formed at an outer end (i.e., the upper end in FIG. 5) of the extending portion 53, and the vent 51 may extend through the extending portion 53. There is a predetermined distance between the flange 54 and the outer wall surface of the battery shell 5, and a plurality of through-holes may be formed in the flange 54, so that the lower ends of the support bars 3 may pass through the through-holes and then may be fixed to the flange 54 by nuts. Therefore, it is convenient to assemble the support bars 3. The other structures of the explosion-proof device 100 shown in FIG. 4 may be the same as those of the explosion-proof device 100 shown in FIG. 3, so that a detailed description thereof will be omitted here.

According to the embodiment of the present disclosure shown in FIG. 5, the depth of the vent 51 may be increased by providing the extending portion 53 so as to increase the size of the valve core 1 in the inside and outside direction, thus increasing the contact area between the valve core 1 and the vent 51. Therefore, the sealing performance may be enhanced. In addition, by forming the flange 54 at the outer end of the extending portion 53, the support bars 3 may be convenient to assemble.

The flange 54 and the extending portion 52 may be integral with the battery shell 5. Alternatively, the flange 54 may be welded onto the outer end of the extending portion 53 after being formed separately. The extending portion 53 may be integral with the flange 54, and then the integrated extending portion 53 and flange 54 may be welded onto the battery shell 5.

Referring to FIG. 5 and FIG. 6, the operation of the explosion-proof device 100 according to an embodiment of the present disclosure will be described below.

As shown in FIG. 5, when the battery operates normally, that is, the internal pressure of the battery is less than the critical safety value, the inward (i.e., downward in FIG. 5) pushing force applied to the valve core 1 by the elastic element 2 is greater than the outward (i.e., upward in FIG. 5) pushing force applied to the valve core 1 by the gas inside the battery, so that the valve core 1 may tightly contact with the inner surface of the vent 51 so as to seal the vent 51.

When the battery is subject to heat or short circuit, the internal pressure may rise to reach or exceed the critical safety value, so that the upward pushing force applied to the valve core 1 by the gas inside the battery may be greater than the downward pushing force applied to the valve core 1 by the elastic element 2 so as to push the valve core 1 to move upwards, and consequently the vent 51 is opened and the gas is discharged via the gap between the valve core 1 and the vent 51 so as to release the internal pressure.

With the discharging of the gas, the internal pressure drops, thus ensuring the safety of the battery. The larger the pressure inside the battery, the wider the gap is, that is, the larger the opening of the vent 51 is, so that the gas inside the battery may be discharged more quickly.

When the internal pressure is lower than the critical safety value, the upward pushing force applied to the valve core 1 by the gas inside the battery may be less than the downward pushing force applied to the valve core 1 by the elastic element 2, so that the valve core 1 may move downwards to seal the vent 51 again.

According to an embodiment of the present disclosure, as shown in FIG. 7, a power battery 200 comprising the explosion-proof device 100 may be provided. The power battery 200 may include: a battery shell 5; an electrolyte sealed in the battery shell 5; an electrode assembly disposed in the battery shell 5; and an explosion-proof device 100 as described above mounted on an outer wall of the battery shell 5. The other structures of the power battery 200 may be known to those skilled in the art, so that detailed description thereof will be omitted here.

With the power battery according to an embodiment of the present disclosure, the vent is formed in the battery shell, and the valve core 1 is movably disposed in the vent, so that the battery may be prevented from exploding and simple in structure, low in cost, long in service life, high in reliability and easy to manufacture, assemble and disassemble.

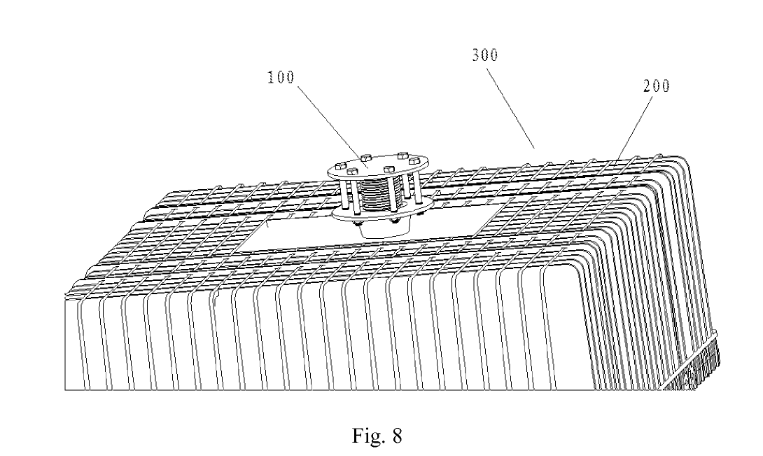

According to an embodiment of the present disclosure, as shown in FIG. 8, a power battery module 300 may be provided. The power battery module 300 may comprise a plurality of power batteries 200 as described above.

Reference throughout this specification to “an embodiment” or “some embodiments” means that a particular feature, structure, material, or characteristic described in connection with the embodiment or example is included in at least one embodiment or example of the disclosure. Thus, the appearances of the phrases such as “in some embodiments” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications all falling into the scope of the claims and their equivalents may be made in the embodiments without departing from spirit and principles of the disclosure.

What is claimed is:

1. An explosion-proof device for a battery, comprising:
a vent formed in a battery shell of the battery;
a valve core movably disposed in the vent to seal and open the vent;
a support mounted on an outer wall of the battery shell; and
an elastic element, wherein one end of the elastic element is connected to the support and another end of the elastic element is connected to the valve core so as to normally push the valve core to seal the vent.

2. The explosion-proof device according to claim 1, wherein the support comprises:
a plurality of support bars disposed around the vent; and
a plate, wherein one end of each support bar is mounted on the battery shell and another end of each support bar is mounted onto the plate.

3. The explosion-proof device according to claim 2, wherein each support bar is a bolt, the plate has a plurality of first holes and the battery shell has a plurality of second threaded holes, and the one end of each support bar pass through one of the first holes in the plate and is screwed in one of the second threaded holes in the battery shell; or wherein the plate has a plurality of first threaded holes and the battery shell has a plurality of second threaded holes, and the one end of each support bar is screwed into one of the first threaded holes in the plate and the second end of each support bar is screwed in one of the second threaded holes in the battery shell.

4. The explosion-proof device according to claim 1, wherein the elastic element is a spring.

5. The explosion-proof device according to claim 4, wherein a length-diameter ratio of the spring is about 2:1 to about 1:1.

6. The explosion-proof device according to claim 4, wherein each of the vent and the valve core has an inverted truncated cone shape.

7. The explosion-proof device according to claim 6, wherein an outer radius of the spring is not less than (⅔) ^{1/2} of a radius of an outer end surface of the valve core, but not greater than the radius of the outer end surface of the valve core.

8. The explosion-proof device according to claim 6, wherein the another end of the spring is connected to a center of the outer end surface of the valve core.

9. The explosion-proof device according to claim 1, wherein the valve core is made of plastics.

10. The explosion-proof device according to claim 1, wherein the outer wall of the battery shell is formed with a boss through which the vent extends.

11. The explosion-proof device according to claim 10, wherein the boss is integral with the battery shell.

12. The explosion-proof device according to claim 1, wherein an extending portion extends from the outer wall of the battery shell, wherein a flange is formed at an outer end of the extending portion, and wherein the vent extends through the extending portion.

13. The explosion-proof device according to claim 12, wherein the flange and the extending portion are integral with the battery shell.

14. The explosion-proof device according to claim 1, wherein a size of the valve core in an inside and outside direction is less than that of the vent in the inside and outside direction.

15. A power battery, comprising:
a battery shell;
an electrolyte sealed in the battery shell;
an electrode assembly disposed in the battery shell; and
an explosion-proof device mounted on an outer wall of the battery shell and comprising:
a vent formed in a battery shell of the battery;
a valve core movably disposed in the vent to seal and open the vent;
a support mounted on an outer wall of the battery shell; and
an elastic element, wherein one end of the elastic element is connected to the support and another end of the elastic element is connected to the valve core so as to normally push the valve core to seal the vent.

16. A power battery module, comprising:
a plurality of power batteries each comprising:
a battery shell;
an electrolyte sealed in the battery shell;
an electrode assembly disposed in the battery shell; and
an explosion-proof device mounted on an outer wall of the battery shell and comprising:
a vent formed in a battery shell of the battery;
a valve core movably disposed in the vent to seal and open the vent;
a support mounted on an outer wall of the battery shell; and
an elastic element, wherein one end of the elastic element is connected to the support and another end of the elastic element is connected to the valve core to seal the vent.
